(19) United States
(12) Patent Application Publication
(10) Pub. No.: US 2002/0152669 A1
(43) Pub. Date: Oct. 24, 2002

(54) Utility strap for fishing equipment

(76) Inventor: Daniel Harvanek, Littleton, CO (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/125,731

(22) Filed: Apr. 17, 2002

Related U.S. Application Data
(63) Continuation-in-part of application No. 09/742,921, filed on Dec. 20, 2000, now abandoned.
(60) Provisional application No. 60/171,767, filed on Dec. 22, 1999.
(60) Provisional application No. 60/230,502, filed on Sep. 6, 2000.

(51) Int. Cl. A01K 97/10

(52) U.S. Cl. 43/21.2

(57) ABSTRACT

A utility support system for fishing equipment or accessory items is disclosed that includes quick-release type fasteners adapted to be secured to a fishermen's clothing at any location with most of the embodiments of the invention including a flexible strap that may include hook-and-loop type fastener material and a rigid loop or strings from which various other articles of fishing equipment or accessory items can be suspended.

### CROSS-REFERENCE TO RELATED APPLICATIONS

This application is a continuation-in-part of U.S. Ser. No. 09/742921, filed Dec. 20, 2000. This application also claims the benefit of U.S. provisional application No. 60/171767, filed Dec. 22, 1999, entitled Anglers' Hands, and U.S. provisional application No. 60/230502, filed Sep. 6, 2000, entitled Sticky Fly-Box. Each of these applications is hereby incorporated by reference as if fully disclosed herein.

### BACKGROUND OF THE INVENTION

1. Field of the Invention

The present invention relates generally to systems for supporting articles of fishing equipment, and more particularly to a utility strap that is quickly and releasably securable to an article of clothing and having releasable fasteners for supporting various articles of fishing equipment.

2. Description of the Relevant Art

Fishing is a sport that requires an unusual amount of equipment and ancillary items, and in addition, normally requires both hands. As a consequence, various types of fishing gear have been developed for accommodating the articles of equipment necessary for fishing including fishing poles, containers for lures, flies, anchors and the like. Some specially designed articles of clothing include an unusual number of pockets to accommodate such items or equipment for fishing, but many times such articles of clothing are in the form of relatively heavy jackets, which are cumbersome, and many times too heavy for relatively warm weather.

While devices have been devised for supporting a fishing pole on one's waist, the devices have typically been fairly complex as is evidenced by U.S. Pat. No. 5,813,162 issued to Tse et al. Similarly, other fishing pole supporting devices have been devised for hands-free use such as of a type that might be affixed to rigid members such as wheelchairs with an example of such being disclosed in U.S. Pat. No. 5,560,137 issued to Herring. The devices known in the prior art for supporting fishing poles and other ancillary fishing equipment have to date been somewhat cumbersome, difficult to operate, or formed as an integral part of an article of clothing and therefore suffer from numerous shortcomings making them less than satisfactory from a utilitarian standpoint.

Accordingly, a simple and convenient device for supporting and carrying numerous and various articles of fishing equipment in a simple easy to deploy manner would be desirable for the sport of fishing.

### SUMMARY OF THE INVENTION

The present invention relates to a utility system that may have as a base component a strap that can be quickly, easily and releasably clamped to an article of clothing with the strap including systems built therein for supporting numerous articles of fishing equipment.

The utility strap has an elongated flexible strip of material having at least one part of a hook and loop type fastener secured thereto and a quick-release connector for releasably connecting the strap to an article of clothing. The one part of hook and loop fastener material can be used to secure the strap to an article of fishing equipment having the other part of the hook and loop fastener, or the strip of material can have both parts of the hook and loop type fastener material so that it can be secured to itself to form a closed loop from which articles of fishing equipment can be suspended.

In the preferred embodiment, the quick-release connector is in the form of an alligator clip that can be quickly and securely connected to any part of an article of clothing such as a T-shirt, fishing shirt, fishing jacket, trousers, or the like. The flexible strip of material preferably has a rigid loop secured to one end thereof opposite the quick-release connector so that other releasable connectors and/or articles of fishing equipment can be suspended therefrom.

Other embodiments of the invention including various systems for releasably securing various articles are also disclosed in various combinations and various embodiments of the invention.

Other aspects, features, and details of the present invention can be more completely understood by reference to the following detailed description of a preferred embodiment taken in conjunction with the drawings and from the appended claims.

### BRIEF DESCRIPTION OF THE DRAWINGS

FIG. 1 is an isometric view of a first embodiment of the utility strap of the present invention in a secured position.

FIG. 2 is an isometric view similar to FIG. 1 with the utility strap in an open position.

FIG. 3 is an isometric view of a fisherman utilizing a pair of the utility straps shown in FIG. 1 for supporting a fishing pole.

FIG. 4 is a fragmentary isometric view showing the utility strap of FIG. 1 secured at one end to an article of clothing and supporting a fishing pole while in the closed position of FIG. 1.

FIG. 5 is an isometric view of a fisherman utilizing a second embodiment of the present invention.

FIG. 6 is a fragmentary isometric view of the utility strap of FIG. 5 supporting a plurality of articles of fishing equipment.

FIG. 7 is a partially exploded isometric view of the strap of FIGS. 5 and 6 that are illustrating the use of the strap in supporting various articles of fishing equipment.

FIG. 8 is an isometric view of an open container for releasable attachment to the strap of FIGS. 5-7.

FIG. 9 is a fragmentary isometric view of the strap of FIGS. 5-7 with the strap supporting another releasable connector and a fishing net.

FIG. 10 is a fragmentary isometric view similar to FIG. 9 showing the releasable connector of the fishing net released from the utility strap.

FIG. 11 is an isometric view of still another embodiment of the present invention.

FIG. 12 is an isometric view of an embodiment of the invention similar to FIG. 11 but having a different strap system.

FIG. 13 is an isometric of still another embodiment of the invention utilizing support strings and a releasable clamp.

FIG. 14 is an isometric of still another embodiment utilizing a flexible strap and a plurality of support strings.

FIG. 15 is an embodiment similar to FIG. 14 wherein the strap has been replaced with a Velcro material.

FIG. 16 is an isometric of still another embodiment similar to FIG. 15 but wherein the strap has been modified and additional string supports are provided.

FIG. 17 is an isometric view of a further embodiment of the present invention illustrating a system for suspending from an article of clothing an oil container for fishing use.

FIG. 18 is a section taken along line 18-18 of FIG. 17.

FIG. 19 is an exploded isometric view of the embodiment shown in FIG. 17.

FIG. 20 is an isometric view of a modification to the embodiment shown in FIG. 17 with a supply of fishing line added to the oil container.

FIG. 21 is a section taken along line 21-21 of FIG. 20.

FIG. 22 is an exploded isometric view of the embodiment shown in FIG. 20.

FIG. 23 is an isometric view of an embodiment similar to FIG. 20 further including a pair of hooks for suspending additional articles of fishing equipment.

FIG. 24 is a section taken along line 24-24 of FIG. 23.

FIG. 25 is an exploded isometric view of the embodiment shown in FIG. 23.

### DESCRIPTION OF THE PREFERRED EMBODIMENT

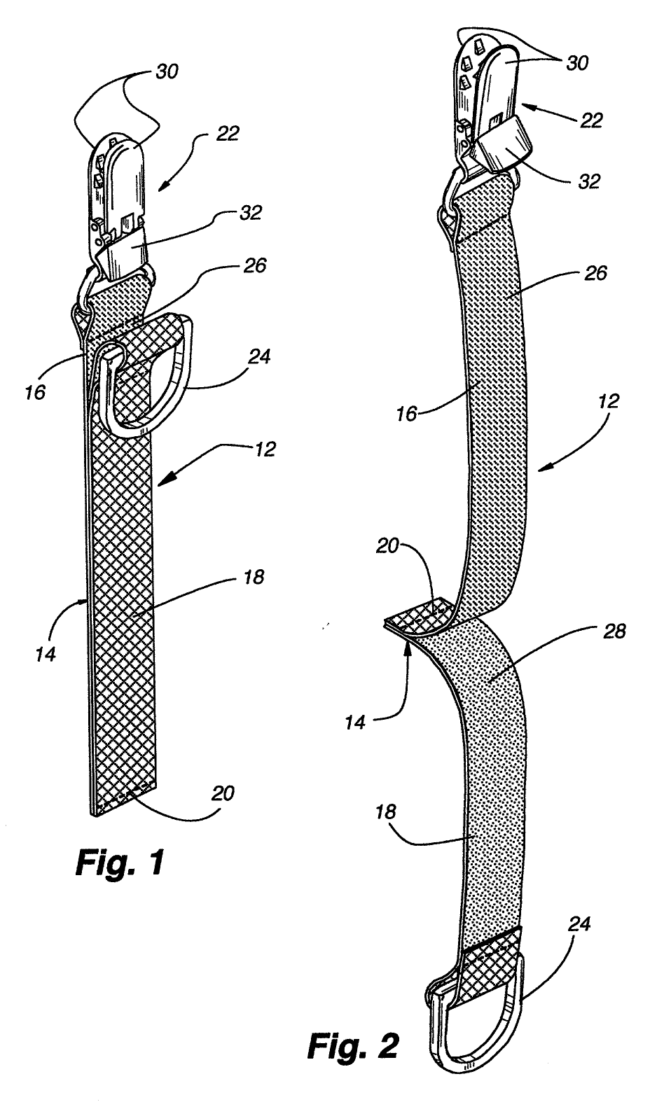

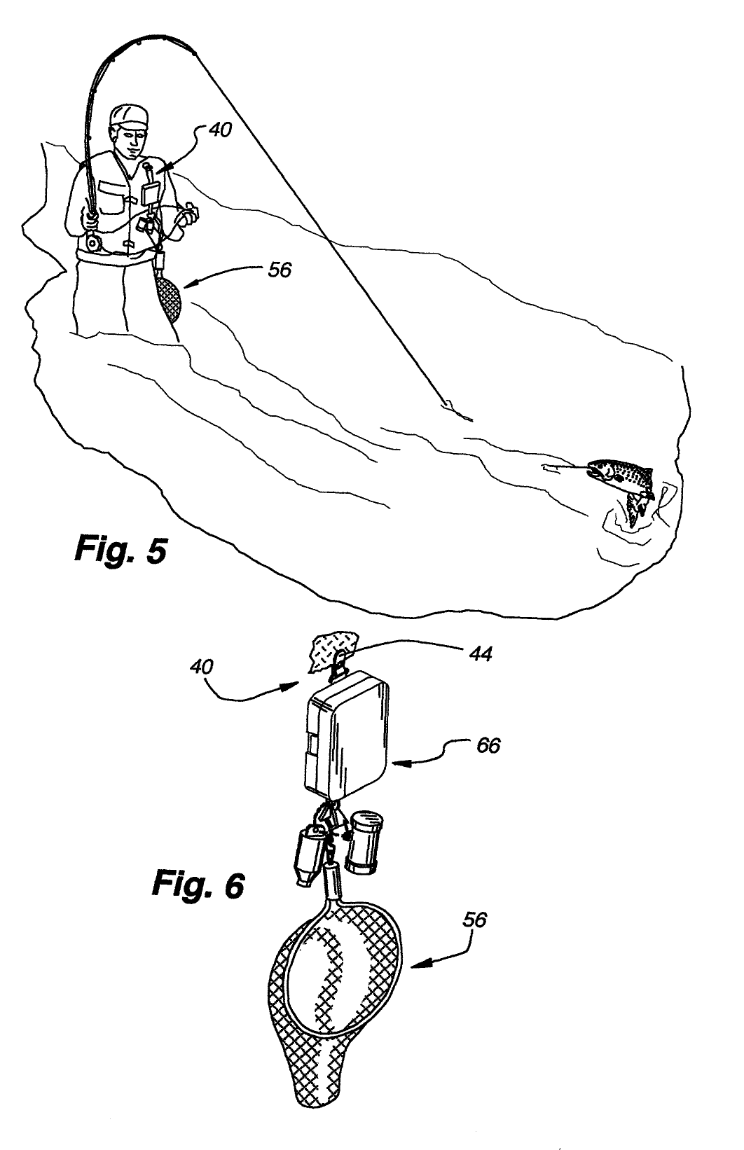

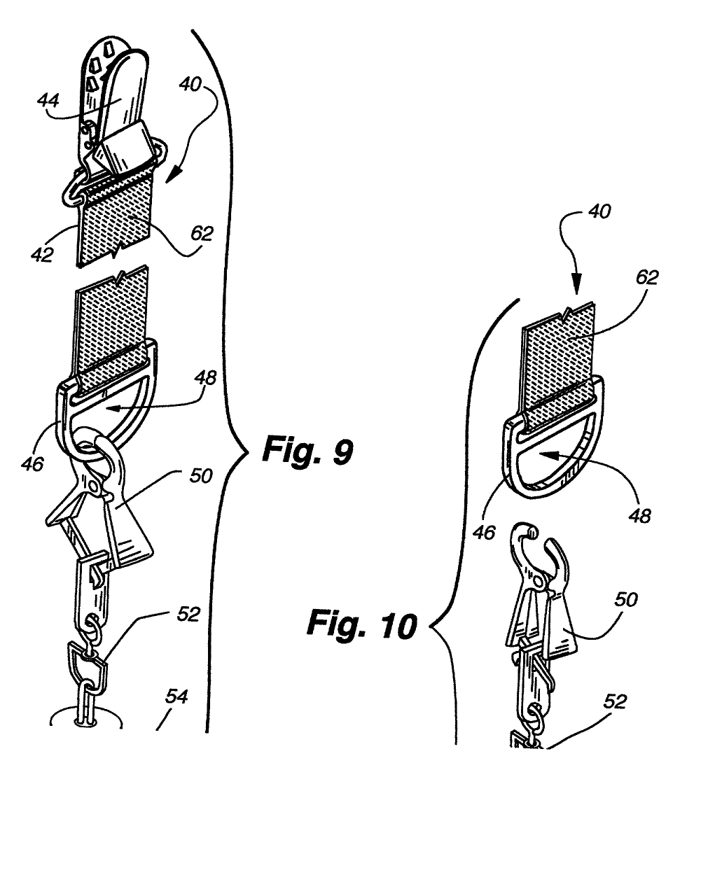

The fishing utility strap of the present invention is designed to be quickly, easily and releasably connected to any article of clothing worn by a fisherman and adapted to support various fishing accessories or items of equipment. The invention is disclosed in two embodiments with the first embodiment illustrated in FIGS. 1-4, and the second embodiment in FIGS. 5-10.

A first embodiment12 of the utility strap of the present invention, as probably best seen in FIGS. 1 and 2, includes a strip14 of material having two components16 and 18 secured together along a line of joiner 20 at one end of the components. One of the components 16 has a quick-release alligator clip or clamp 22 at the opposite end and the other strip component 18 has a rigid loop 24 at its opposite end. One of the components 16 of the flexible strip material has one part 26 of a hook and loop type fastener on one face thereof and the other component 18 has the second part 28 of a hook and loop type fastener on a face thereof with the faces containing the hook and loop material being confronting so that they can be releasably connected in the closed position of FIG. 1 such that the alligator clip or clamp 22 is disposed adjacent to the rigid loop 24. When the hook and loop material is released, as in the open position of FIG. 2, the alligator clip and rigid loop are at opposite ends with the line of joiner 20 between the two components of material being at an intermediate location. The component parts of the strip of flexible material can be any relatively strong material such as nylon or the like and have the hook and loop type fastener material secured along one face of its entire length. For purposes of the present disclosure, a hook and loop type fastener material, such as is commonly marketed under the trademark Velcro® would be suitable and will be described as having two parts, a hook part and a loop part. As is well known in the art, the hook part is adapted to be releasably connected to the loop part when the parts are engaged in face-to-face relationship.

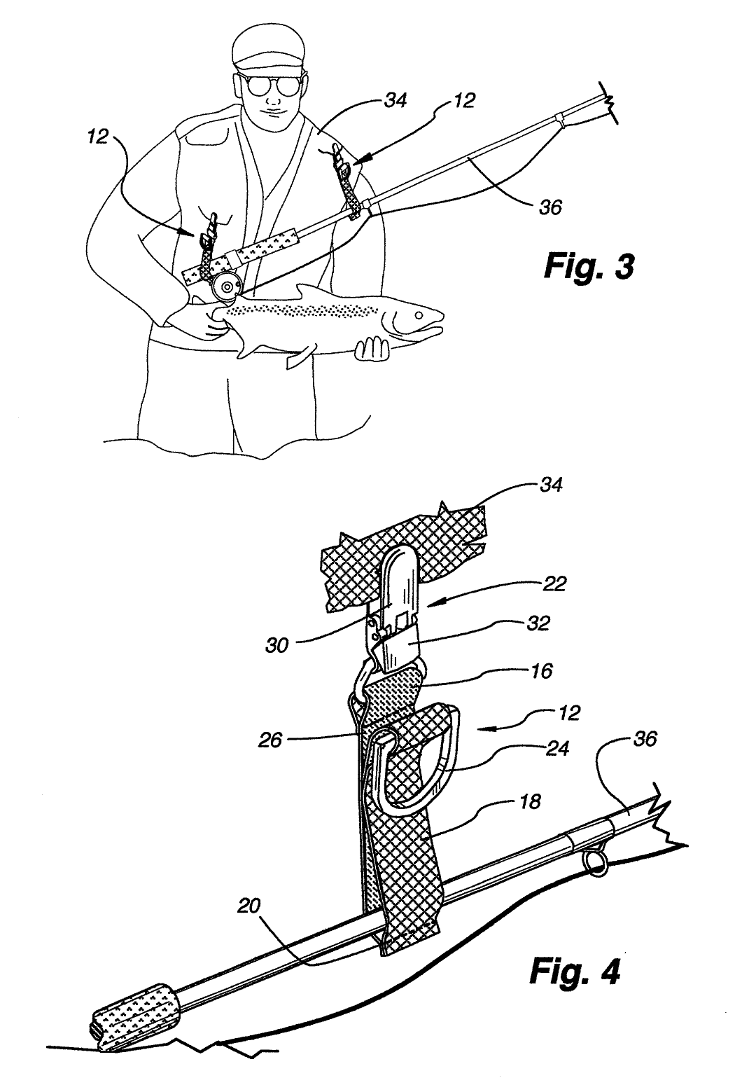

With reference to FIGS. 1 and 2, the alligator clip or clamp 22 is of a conventional type having a pair of locking jaws 30 that are pivotally connected together and releasably secured in a locked confronting relationship by a lock tab 32. The alligator clip is ideally suited for securing the utility strap 12 to an article of clothing 34 (FIG. 3) or the like at any location simply by inserting a portion of the article of clothing into the open jaws of the alligator clip and then securing or locking the clip in a closed position by pivoting the lock tab 32 downwardly (FIG. 1), which forces the locking jaws into a clamping relationship with the article of clothing releasably secured therebetween.

As mentioned, the alligator clip 22 is adapted to releasably clamp or secure the utility strap 12 to an article of clothing and the rigid loop 24 is adapted to support fishing accessories as will be described in more detail later. The components 16 and 18 of the strip 14 of material, however, can be selectively connected at any location along their length (FIG. 4) via the hook and loop material so that other fishing equipment or accessory items can be supported between the two components.

As illustrated in FIGS. 3 and 4, and by way of example, a fishing pole 36 can be supported by the strip 14 by passing a portion of the pole between the two components 16 and 18 of the strip and then securing the components together via the hook and loop fasteners around the fishing pole. By utilizing two of the utility straps 12 as illustrated in FIG. 3, a fishing person can suspend a fishing pole from his or her clothing in a hands-free manner so the hands can be used for other purposes or can simply be put in the user's pockets for example on a cold day.

It will be appreciated from the above that the utility strap 12, illustrated in FIGS. 1-4 not only includes a rigid loop 24 from which various items can be permanently or releasably suspended, but an additional system for positively confining fishing equipment or accessories by forming a closed loop around the equipment or accessories.

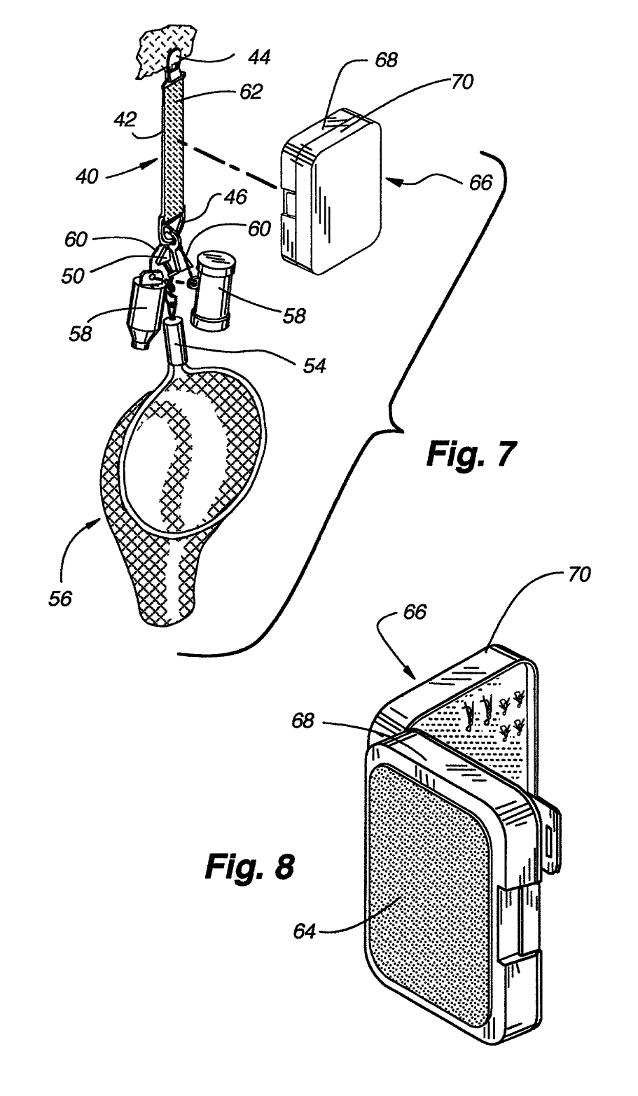

Looking next at FIGS. 5-10, and particularly at FIG. 7, a second embodiment 40 of the utility strap of the invention is shown. The utility strap 40 can be seen to include a strip 42 of flexible material having a quick-release alligator clip or clamp 44 secured at one end and a rigid loop 46 at the other end. The alligator clip and rigid loop could be identical or substantially identical to those used and described in connection with the first embodiment.

The rigid loop 46 is a conventional item, which can be made of plastic, metal, or the like, defines a relatively large semi-circular slot 48 in which items can be connected permanently or releasably to the strap 40.

In the illustrated use of the utility strap 40, a releasable clamp member 50 is connected to the rigid loop 46 and in turn supports a D-shaped-ring 52 from which the handle 54 of a fishing net 56 is suspended. The releasable clamp member 50 can be easily removed from the rigid loop 46 so that a fisherman can independently use the fishing net or it simply can be suspended from the utility strap when not in use. Other fishing accessories 58 are shown in FIGS. 6 and 7 suspended from the rigid loop such as by releasable beaded chains 60 and by way of example, the other fishing accessories might be containers of float material commonly used by fisherman. Of course, any other accessory item could also be suspended from the rigid loop.

At least one face of the strip material 42 has one part 62 of a hook and loop type fastener material thereon and it is adapted to cooperate with the other part 64 of a hook and loop material which is secured to a fishing accessory that a fishing person may want to suspend from the utility strap. By way of example, one face of a box or container 66, such as of the type that might include fishing flies, lures, or the like, might have the other part of the hook and loop material thereon. In the disclosed embodiment, as probably best seen in FIG. 8, the container 66 has a base component 68 and a hingedly connected top 70, which are connected together with the base 68 having a sheet of the second part 64 of the hook and loop material secured thereto. The container can thereby be easily connected to or removed from the utility strap simply by applying a pulling force to the container which releases the two parts of the hook and loop material.

It will therefore be appreciated that the first and second embodiments of the utility strap of the present invention are readily adapted for supporting various types of fishing accessories or equipment in different ways.

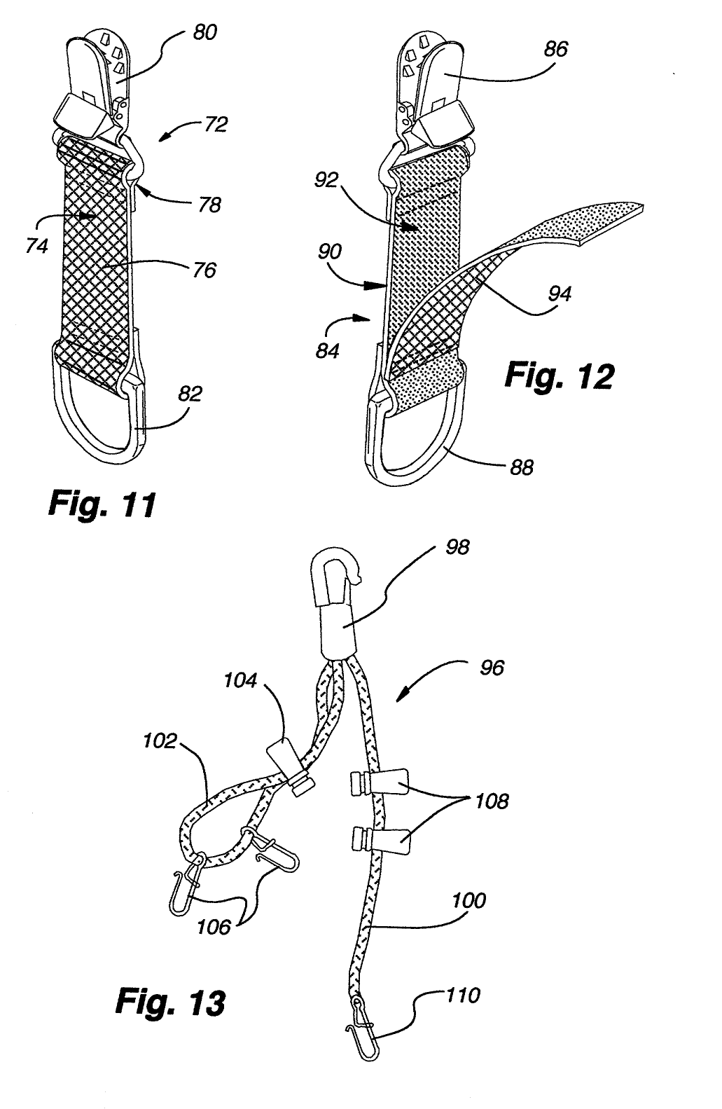

A further embodiment 72 of the utility system of the present invention is shown in FIG. 11 wherein a strap 74 has a flexible strap component 76 of webbing or the like being folded back upon itself at each end and sewn to itself to define an enclosed passage 78 for securing at one end of the strap an alligator clip or clamp 80 and at the other end a D-ring 82. As will be appreciated, in this embodiment, the alligator clip is used to secure the flexible strap to an article of clothing or the like and the D-ring can be used for attachment to various articles of equipment or the like as described previously with other embodiments.

Still another embodiment 84 of the utility system of the present invention is illustrated in FIG. 12 with this embodiment being similar to that of FIG. 11 in that it includes an alligator clip or clamp 86 at one end and a D-ring 88 at the opposite end, both secured to a flexible strap 90. The flexible strap 90 is itself a two-piece Velcro system with one component 92 of the Velcro system, for example the looped material, forming a base for attachment to the alligator clip and the D-ring. The other component 94 of the Velcro system, i.e. the hook material, being secured as by stitching at one end to the looped material component 90 and being releasably engageable with the base or loop portion through engagement. With this strap, it will be appreciated that articles can be confined between the loop and hook portions of the Velcro as previously described, for example, in the embodiment of FIG. 4.

FIG. 13 illustrates a utility system 96 that itself can be releasably connected to a utility strap of the type disclosed in the previously described embodiments of the present invention. The utility system could also be releasably connected directly to an article of clothing. The utility system 96 shown in FIG. 13 includes a releasable lock clamp 98 that can be secured, for example, to the D-ring of FIG. 11 or 12 or to the belt or belt loop (not shown) of a fisherman or to any other location. A pair of flexible strings 100 and 102 are secured to the releasable lock clamp so as to hang downwardly therefrom and in the disclosed embodiment, there is one straight string 100 and a string 102 that had been formed into a closed loop. The closed loop string has an adjustable string trap 104 of a conventional type which is adapted to receive two strands of string and can be moved along the strands to any location so as to enlarge or shrink the size of the loop formed by the string. Also on the looped string 102, there are two hooks 106 which can be used to support various accessory items. The other string 100 suspended from the releasable clamp has two adjustable string traps 108 secured thereto which can be used to form and secure a loop in the string or simply to define three identifiable segments of the string, namely on either side of the string traps and in between the string traps along which other articles can be secured to the utility system. A hook 110 is also provided on the end of the strings to which articles and other fishing accessory items can be releasably supported.

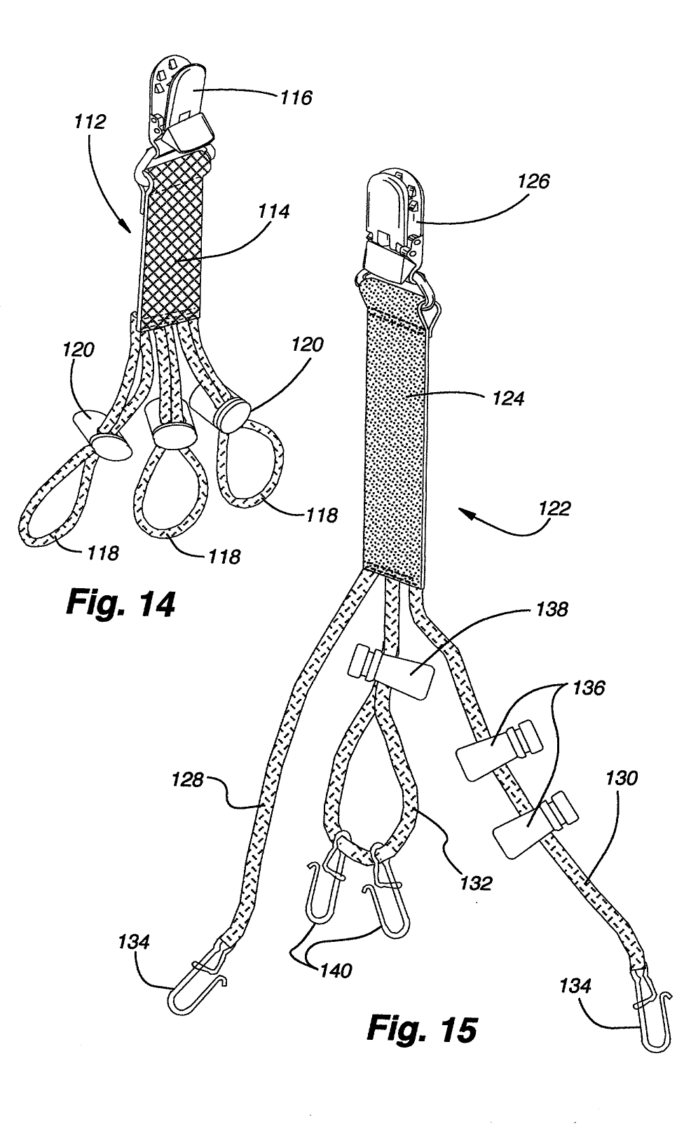

FIG. 14 discloses still another embodiment 112 of the present invention wherein a flexible strap 114 is looped back upon itself at an upper end to define an enclosed area for trapping and securing an alligator clip or clamp 116 with the opposite end of the flexible strap supporting three looped strings 118. The strap itself is simply flexible webbing and the strings in the disclosed embodiment are secured to the lower end of the webbing with stitching or the like. Each string is formed in the shape of a loop and includes an adjustable string trap 120 to adjust the size of the loop in a conventional manner as described above. Of course, various articles or accessories can be supported from each string and tightened or secured in place by adjustment of the associated string traps.

A further embodiment 122 of a utility strap of the present invention is shown in FIG. 15 to include a flexible strap 124 composed of one half of a hook-and-loop type fastener which has been folded back upon itself at the top and secured to itself as by stitching so as to secure an alligator-type clamp 126 thereto. The opposite end of the flexible strap has three strings 128, 130 and 132 secured thereto as by stitching with two of the strings 128 and 130 being simply strands having hooks 134 secured to the ends thereof for supporting various objects. One of the strings 130 also has a pair of adjustable string traps 136 and would function similarly to FIG. 13. The third string 132 is formed into a loop which is adjustable and has a string trap 138 secured thereto. The third string also carries a couple of hooks 140 so that various items can be suspended from the hooks or clamped within the loop by adjustment of the string trap. Another object, such as a container of the type shown in FIG. 8, having the other half of a hook-and-loop type material thereon can be releasably attached to the flexible strap as by compressing the hook-and-loop material into engagement.

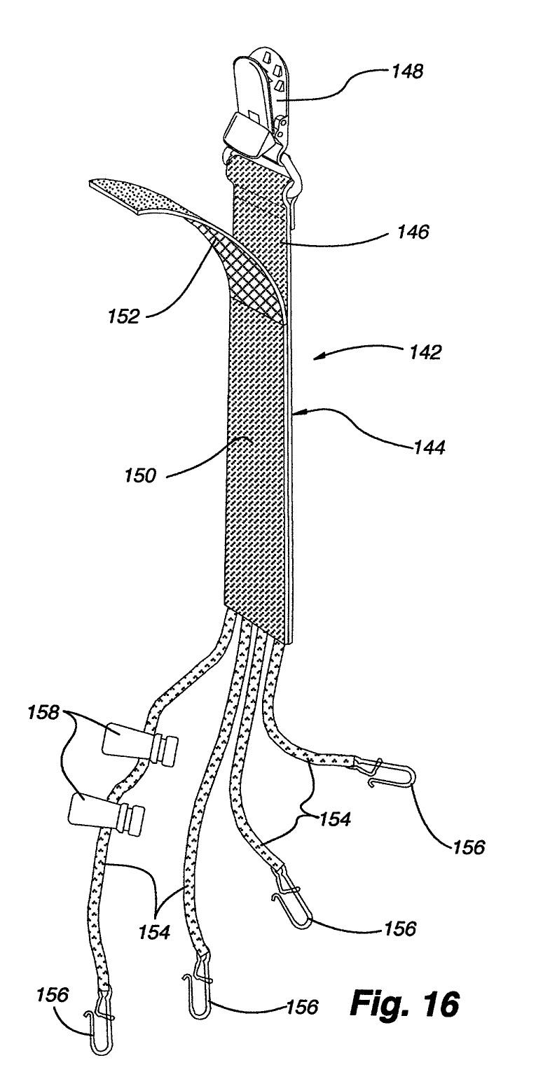

Another embodiment 142 of a utility system in accordance with the present invention is illustrated in FIG. 16 and can be seen to include a flexible strap 144 composed of three component parts with the primary or base component part 146 being half of a hook-and-loop type material such as, for example, the loop material, with the top end of the loop material being folded back upon itself and secured to itself to define an enclosure for securing an alligator clip or clamp 148. Another strip of material 150 having a hook fastener material on one face and a loop fastener material on the opposite face is releasably secured to a lower majority portion of the base component part 146 as by engaging the looped portion of the strip to the hook portion of the base strap. Immediately above the second strip of hook-and-loop material is a third piece of material 152 which could be simply webbing having an internal face of hook material thereon adapted to releasably engage the loop material at the upper end of the base component 146. In this manner, an article of equipment can be trapped between the third piece of material and the base component and confined therebetween by attachment of the flexible strips of material. The lower majority of the flexible strap 144 can be used to secure a container or the like such as shown in FIG. 8 having the complementary hook-and-loop material secured thereto. Suspended from the bottom of the flexible strap material are four elongated strings 154 each having a hook 156 on the end thereof for supporting various articles or accessories and one of the strings having a pair of adjustable string traps 158 so that it can function similarly to the system shown in FIG. 13.

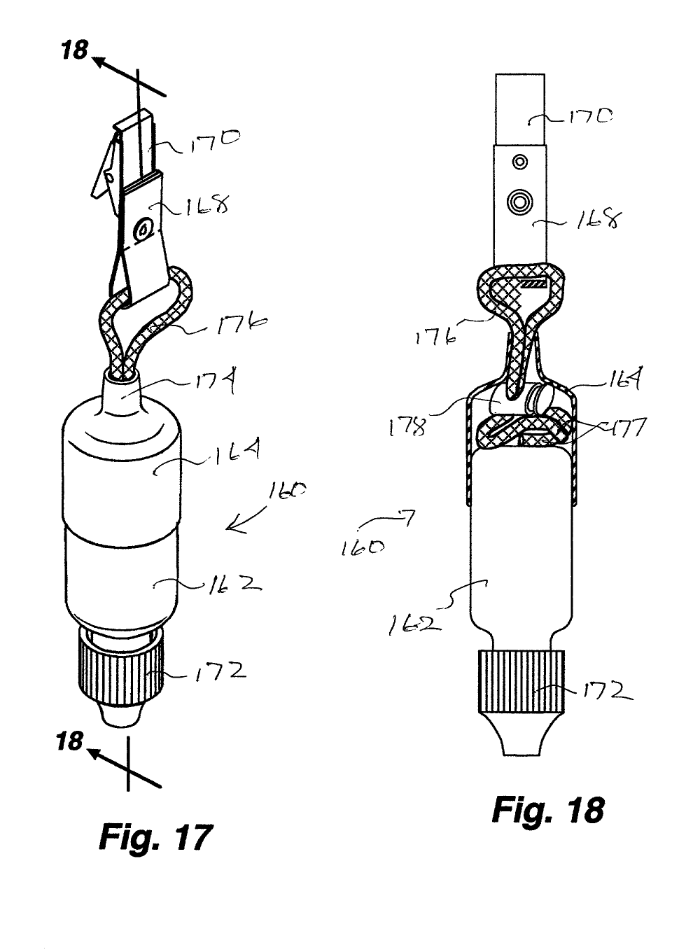

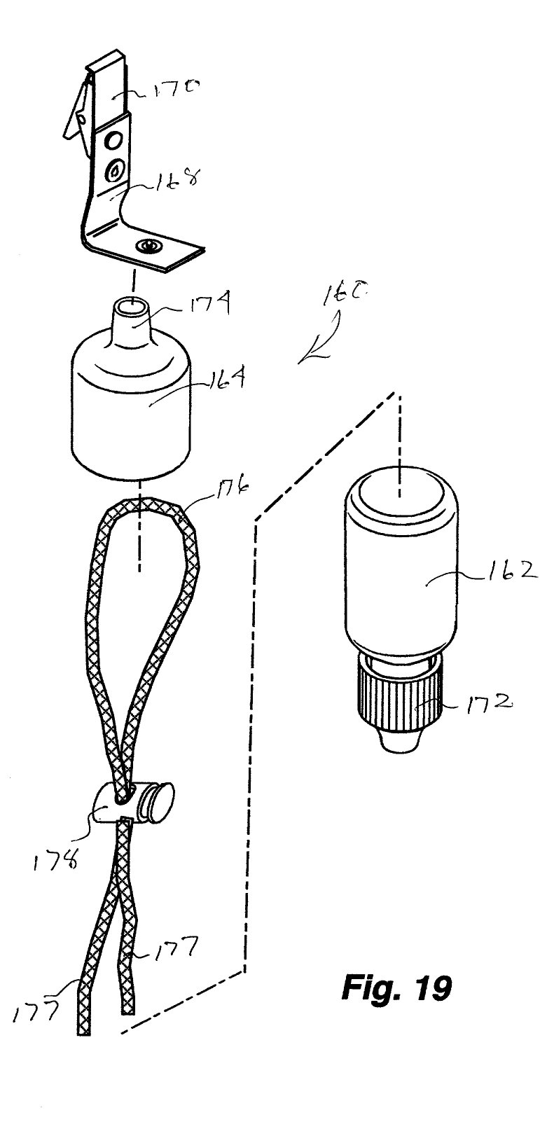

A still further embodiment 160 of the utility device present invention is shown in FIG. 17-19 where a container 162 in the form of a bottle-type container of oil or the like is suspended from a downwardly opening flexible rubber sleeve-type support 164 that in turn is supported by a flexible cord 176 from a closed loop tail 168 of an alligator clip or clamp 170. The oil is conventionally used to put on flies for fly-fishing purposes to improve the buoyancy of the flies. The bottle-type container is suspended in an inverted orientation with a removable cap 172 on the bottom thereof threaded onto a threaded neck (not shown) of the bottle so that by removing the cap, the oil confined in the bottle can be applied to flies for buoyancy. If desired, the bottle can be removed from the flexible rubber sleeve 164 which merely frictionally retains the container in the inverted orientation shown in the drawings but wherein the container can be inserted into or removed from the rubber sleeve with appropriate pressure and manipulation. The rubber sleeve has an upwardly directed neck 174 with an opening therethrough that communicates with the hollow interior of the rubber sleeve. A flexible cord 176 having two free ends 177 is confined within the flexible sleeve above the bottle and the ends are secured together with a string or cord trap 178 so as to define a closed loop in the cord which projects upwardly through the neck of the sleeve. The closed loop is secured to the closed loop tail on the alligator clip or clamp so the sleeve, cord and bottle can be suspended from an article of clothing by clamping the alligator clip to the article of clothing.

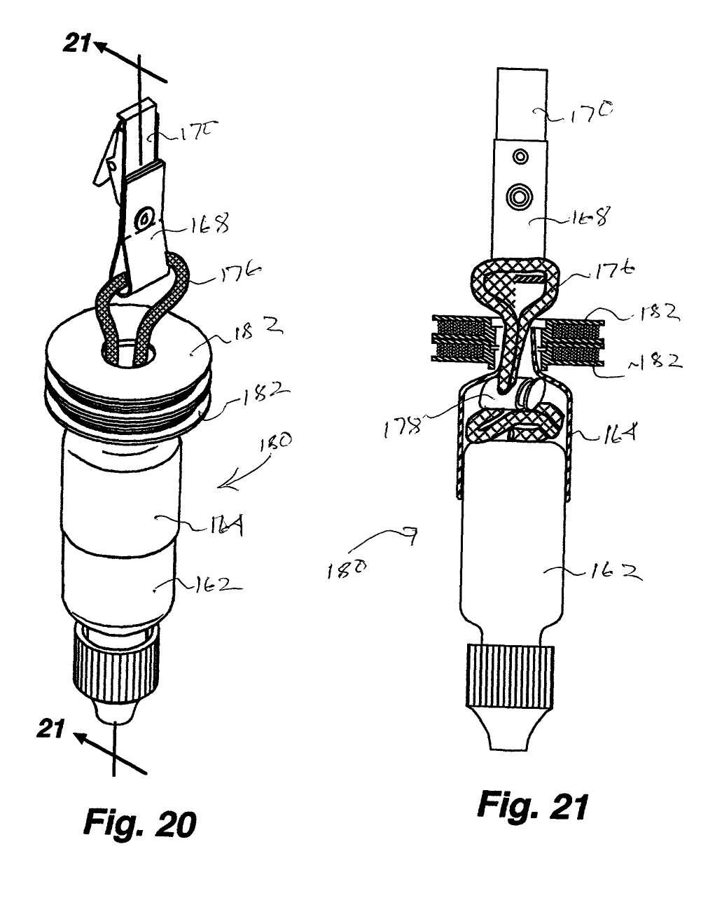

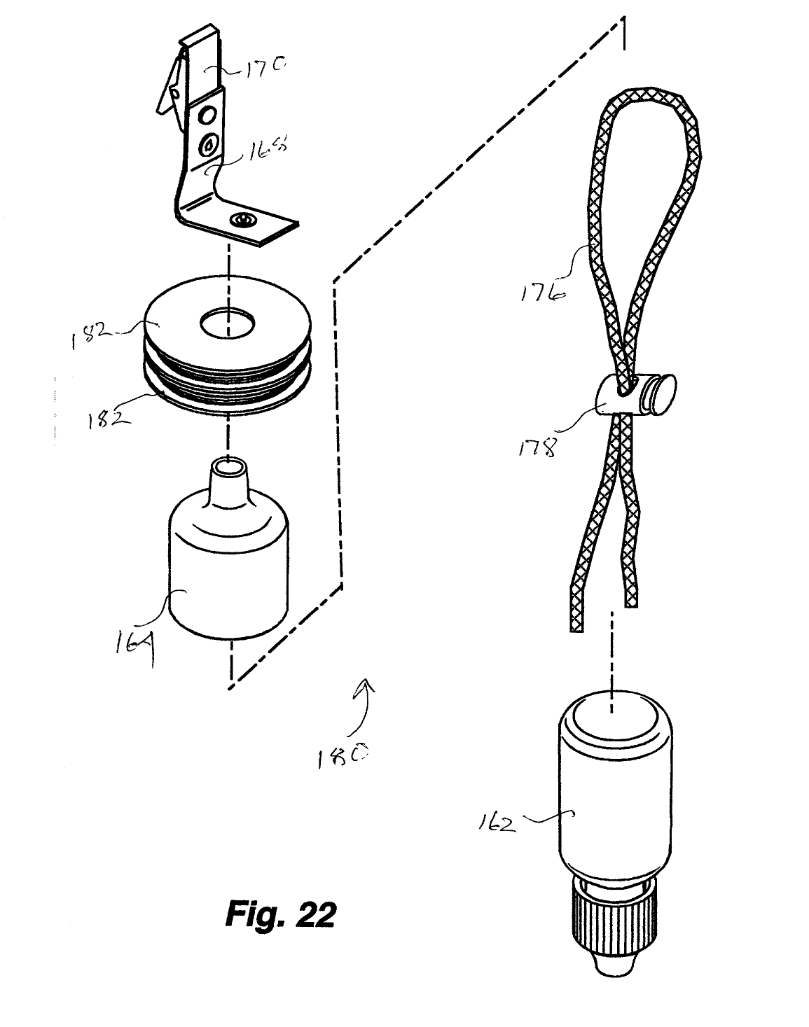

In another related embodiment 180 to that of FIG. 17-19 shown in FIGS. 20-22, the utility device is identical in having an inverted bottle 162 of oil or the like suspended from a flexible rubber sleeve-type support 164, a flexible cord 176 partially confined in the sleeve and an alligator clip 170 with a closed-loop tail 168 supporting the flexible cord, but in this embodiment, a pair of spools 182 of fishing line are positioned around the neck 174 of the sleeve and the flexible cord 176 projecting upwardly therefrom so the fishing line can be easily accessed if needed to replace the fishing line on a fisherman's pole. Of course, the fishing line can be removed from the utility device simply by removing the flexible cord 176 from the rubber sleeve 164 which is accomplished by sliding the cord or string trap 178 off the end of the cord allowing at least one free end of the cord to be removed from the rubber sleeve thereby freeing the spools of fishing line.

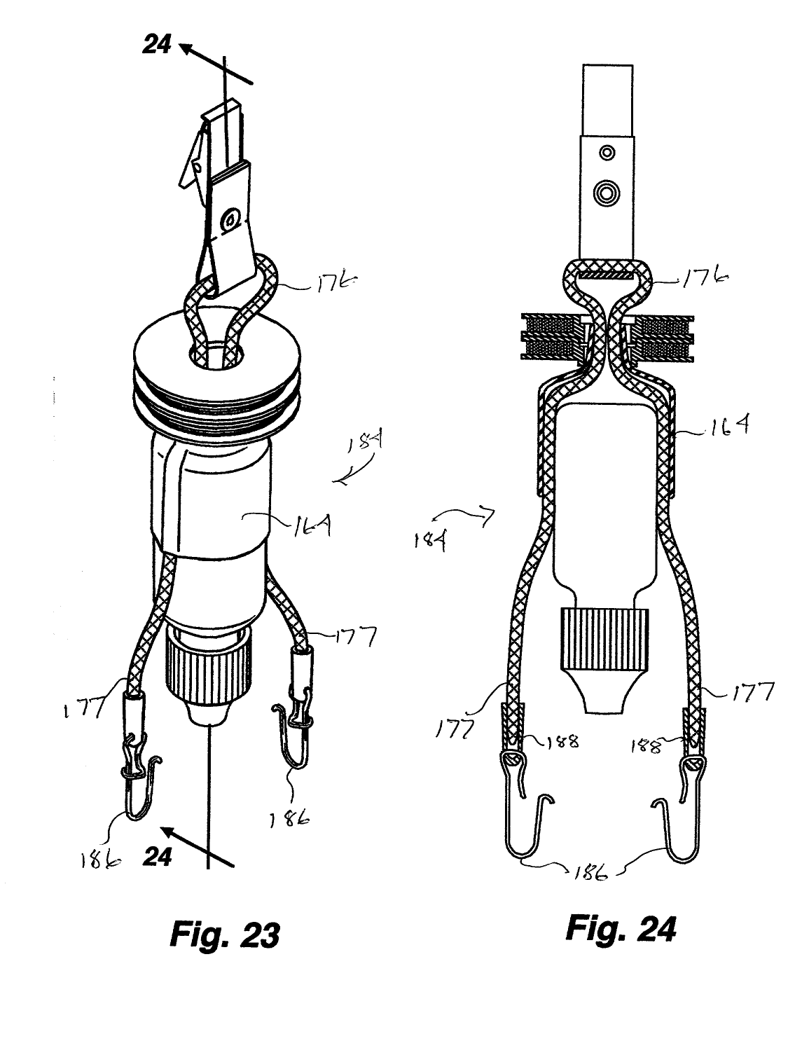

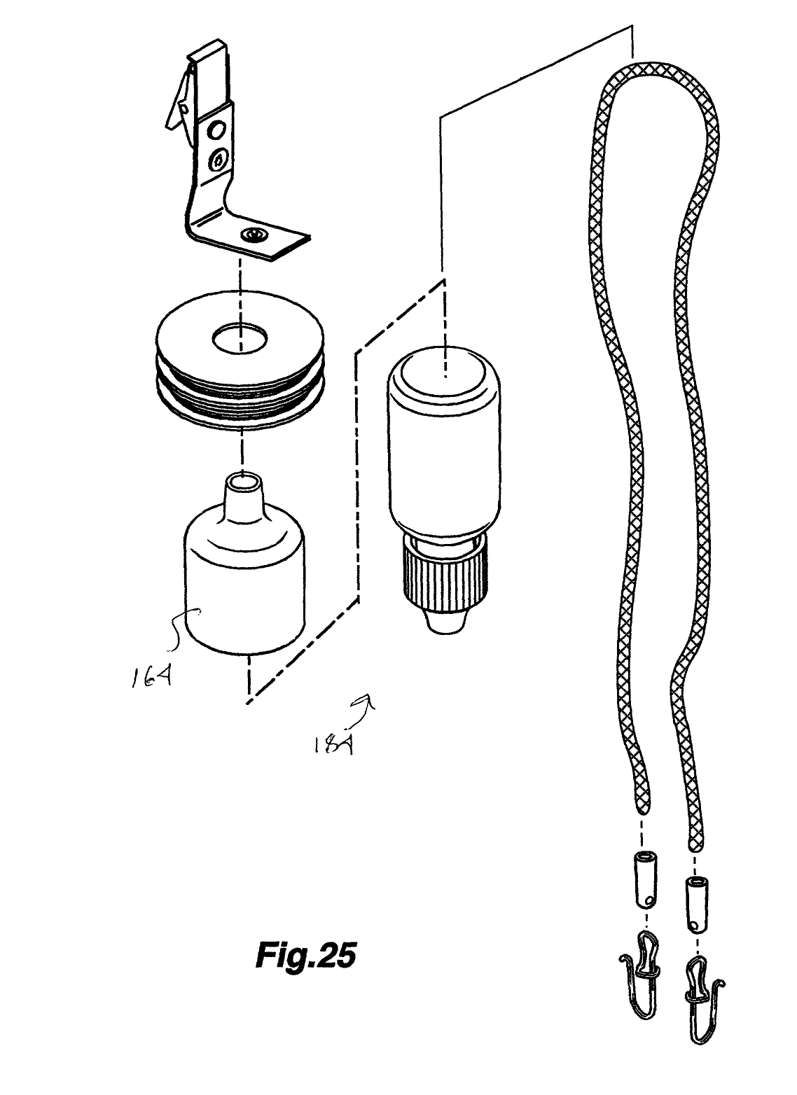

FIGS. 23-25 show still another embodiment 184 of a utility device similar to those shown in FIGS. 17-22, but, in this embodiment, the flexible cord 176 is not confined within the rubber sleeve 164 with a string or cord trap but rather the two free ends 177 of the cord have been allowed to project and depend from the rubber sleeve 164 with hook members 186 being suspended on the free ends of the cord by the use of rubber caps 188 that can be adhesively or otherwise secured to the free ends of the cord. In this embodiment of the device, it will be appreciated that the device not only includes the bottle 162 of oil with the rubber sleeve 164, spools 182 of fishing line, and alligator clip 170, but also the hooks 186 which can be used to suspend other fishing accessories (not shown).

It will be appreciated from the above that many variations of the basic components described can be utilized in numerous combinations with many such combinations not illustrated or described herein but which would be readily apparent to those skilled in the art from the embodiments that are described. The various utility systems can be used in various combinations or individually for supporting numerous accessories and articles of equipment.

Although the present invention has been described with a certain degree of particularity, it is understood that the present disclosure has been made by way of example, and changes in detail or structure may be made without departing from the spirit of the invention as defined in the appended claims.

I claim:

1. The combination of a utility strap and at least one piece of fishing equipment and an article of clothing wherein said utility strap comprises:
an elongated flexible strip having at least one part of a hook-and-loop fastener extending along the length thereof, a clamp-type, quick-release connector secured to the strip and releasably secured to said clothing, said at least one part of a hook-and-loop fastener being adapted to be releasably connected to at least one piece of fishing equipment, and at least one elongated cord secured to said strip, said cord having a connector device thereon for connection to fishing equipment.

2. The combination of claim 1 wherein said cord is formed into an adjustable loop for attachment to said fishing equipment.

3. The combination of claim 2 further including an adjustable clamp secured to said at least one cord adapted to adjust the size of said loop in the cord and releasably retain the size of the loop.

4. The combination of claim 3 wherein there are a plurality of said cords, some of which include adjustable clamps connected thereto.

5. The combination of claim 1 wherein said strip includes both parts of a hook-and-loop fastener which are permanently connected to at least one location and releasably connectible at other locations.

6. The combination of a utility support system, at least one piece of fishing equipment and an article of clothing wherein said utility support comprises:
a releasable hook, and
at least one flexible cord secured to said releasable hook having a connector device thereon for being connected to said at least one piece of fishing equipment, and
a releasable clamp releasably connected to said article of clothing.

7. The combination of claim 6 wherein there are a plurality of said cords, at least one of said cords being formed into an adjustable loop for attachment to said fishing equipment.

8. The combination of claim 7 further including an adjustable clamp secured to at least one of said cords and adapted to adjust the size of said loop in the cord and releasably retain the size of the loop.

9. The combination of a utility support system and said article of clothing wherein said utility support system includes:
a clamp releasably clamping the utility support system to an article of clothing,
a bottle of liquid used on fishing equipment,
a support for the bottle, and
a flexible connector for interconnecting the support and the clamp.

10. The combination of claim 9 wherein said support is a releasable support such that said bottle can be connected to or released from said support.

11. The combination of claim 10 wherein said flexible connector is a cord.

12. The combination of claim 11 wherein said cord has two free ends and a cord trap for securing the ends of the cord together.

13. The combination of claim 9 further including at least one spool of fishing line supported on said flexible connector.

14. The combination of claim 11 wherein said cord has two free ends that are confined within said support.

15. The combination of claim 11 wherein said cord has two free ends that are not confined within said support and include hook members for releasably supporting articles of fishing equipment.
